(19) United States
(12) Patent Application Publication
(10) Pub. No.: US 2009/0199783 A1
(43) Pub. Date: Aug. 13, 2009

(54) DOOR-MOUNTED PET PERCH

(76) Inventor: Candice A. Wilmore, Lansing, MI (US)

Correspondence Address: DONALD W. MEEKER, 924 EAST OCEAN FRONT, # E, NEWPORT BEACH, CA, 92661, US

(21) Appl. No.: 12/028,802

(22) Filed: Feb. 9, 2008

(51) Int. Cl. A01K 13/00

(52) U.S. Cl. 119/702

(57) ABSTRACT

A hanger formed of a pair of aligned inverted square U-shaped hooks of thin strong material fit snugly over the top of a door with no fasteners or tools required. A pet perching ledge pivots down from the adjacent legs of the hanger to extend horizontally out from the face of the door for use and pivots up for storage. A pet cushion may be installed on the perching ledge.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to animal perches and particularly to a door-mounted pet perch which comprises a fold-down perching ledge or platform or shelf upon which the animal may rest that is hung over a door using two mounting brackets pivotally attached to the back edge of the ledge, each mounting bracket being formed with legs in an upside down square “U” shape of pre-selected width to fit snugly over the top edge of said existing door and not interfere with the operation of the door; the ledge is pivotally attached to the mounting brackets so that it may be folded up when not in use.

2. Description of Related Art Including Information Disclosed Under 37 CFR 1.97 and 1.98

It is well known that cats like a place to perch in high places out of the way of human traffic. Cats love to be in the highest place in the room. From this vantage point the can better observe their surrounding or rest and preen themselves undisturbed.

There are prior art window sill “perches” for cats, but no portable instantly and easily installed perch ledges for a door.

Door mounted storage units or organizers are well known in prior art, some of which comprise a shelf or shelf-like members hung by inverted U-shaped brackets that are mounted over the tope edge of the door, examples may be found in U.S. Pat. Nos. 1,189,677; 2,270,796; 2,483,051; 2,508,527; 2,633,998; 2,677,585; 5,875,902; 5,894,940; 6,857,528; and 7,118,001.

Wall-mounted, window sill mounted and outdoor perches for cats are also known in the prior art, examples of which can be found in U.S. Pat. Nos. 2,579,797; 3,173,398; 3,857,365; 4,057,031; 5,002,012; 5,337,697; 5,351,648; 5,794,385; 5,809,933; and 6,360,689.

Other prior art fails to provide an instant easy way to provide an elevated perch ledge for pets.

U.S. Pat. No. 5,275,128, issued Jan. 4, 1994 to Barnes, provides a roll up cat scratching pad with horizontal ledges. The roll up cat scratching pad has flanges for securing the ends to the top and bottom of a door. A flexible base member provides rollup ability and vertical support for extended horizontal platforms. These provide for resting and exercising of animals, e.g. felines, and extend away from the flexible base member. The extended platforms include tubular shaped tunnels and flat shaped ledges. A frontal strap extends vertically across the apparatus for further vertical support. Cat resistant material e.g. carpeting may be used to cover the apparatus especially the resting perches. Attachment devices at the top and bottom of the pad allow it to be secured to the top and bottom of structures e.g. doors. The pad may be rolled up for easy transport.

U.S. Pat. No. 5,829,390, issued Nov. 3, 1998 to Jonilla, is for a door-mounted, scratch, exercise and perch structure for cats having a linearly elongated shaft, a base support mounted to the base of said shaft, a horizontally elongated loft for spanning the width of an otherwise conventional interior doorway, and a plurality of platforms, said platforms attached to said shaft in a linearly spaced manner, said platforms forming a series of platforms a sufficient number to allow ascent and descent by cats.

U.S. Pat. No. 6,000,365, issued Dec. 14, 1999 to Chamesky, claims a removable structure which is placed on and in a car door on which to allow pets to place their paws in order to allow them to place their head outside an open car door window and which provides a support base which serves to support and restrain them during vehicle motion.

U.S. Pat. No. 7,086,352, issued Aug. 8, 2006 to Goodger, describes a door suspended outward facing bird perch which includes an overhang for engaging the top edge of a door. An optional clamp tightens the bird support perch bar in any desirable position. The perch is positioned parallel to, the door, so that the door surface is at the bird's back, which is less confirming visually to the bird. The perch can be moved adjustably outward away from the door. The angle of the perch away from the door can be adjustable as well. A gripping surface is provided upon which the bird can cling or sharpen its claws. Optionally, the perch can be folded flat against the door when stored and not used. In further options the bird perch may have optional food and bowls and/or a litter catch.

U.S. Pat. No. 6,715,447, issued Apr. 6, 2004 to Haber, discloses a clamp-on cat scratching device which may be mounted on a door jamb. The cat scratching post incorporates a clamping mechanism for secure and stable attachment to a receiving object like a door jamb. A resilient main superstructure has an adhesive interface securing a surface material that is appropriate for cats to scratch or climb. A user of the scratching post can pry open the superstructure and clamp it onto a receiving object. The device is an improvement over other scratching posts because of its space saving implications, as virtually no floor area is required. No base is required to stabilize the device; stability is derived from the receiving object combined with the clamping force the scratching post provides. A detachable base element may be incorporated for freestanding use. Perch elements and hanging toys can be attached providing climbing, perching, and playing opportunities.

U.S. Patent Application #20060236896, published Oct. 26, 2006 by Heroux, provides an adjustable window shelf which is removably attachable to a window sill or other structure as a support for potted plants, a pet perch, or the like. The adjustable shelf may be provided with an alternate type of anchor, and may be engaged to other structures, such as retained behind a top edge of a door.

U.S. Patent Application #20050012006, published Jan. 20, 2005 by O'Donoghue, is for a support which is mounted on a door. In alternate embodiments, the support means may comprise a platform for forming a shelf for supporting an article thereon and may have pivot mounting brackets. The pivoting mounting brackets comprise an inverted U-shaped bracket for snugly fitting over the top of the door.

What is needed is a portable perch ledge for pets which instantly installs on a door with no hardware or tools required and one that is instantly removable or transportable to other doors.

### BRIEF SUMMARY OF THE INVENTION

An object of the present invention is to provide a portable perch ledge for pets formed with a hanger comprising a double sided inverted square U-shaped hook with thin hook elements which fit over the top of a door without interfering with the operation of the door and a pivotally attached perching ledge which extends horizontally out from the bottoms of one side of the hooks so that the hanger instantly installs on a door by hooking over the top of the door with no hardware or tools required and one that is instantly removable or transportable to other doors, and the ledge pivots up flat with the attached leg of the hanger for flatter storage.

In brief, the present portable perching ledge invention for pets removably hangs over a top of a door by an inverted square U-shaped hook with two thin hooks fitting flush with the door so that they do not interfere with the operation of the door. A flat horizontal ledge portion is hinged to the bottoms of the hooks on one side and extends perpendicularly away from the door near the top of the door. A pet cushion for the ledge may also be provided. The present invention may be fabricated of molded plastic or fiberglass or fabricated of thin metal plate. There are no hardware or tools required for installing or removing the perching ledge instantly. The perching ledge folds up for easy packing, shipping.

An advantage of the present invention is that the hanger instantly installs on a door by hooking over the top of the door with no hardware or tools required and one that is instantly removable or transportable to other doors.

Another advantage of the present invention is that the ledge pivots up flat with the attached leg of the hanger for flatter storage.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the portable pet perching ledge of the present invention showing the invention mounted with the pair of hooks over the top of a door and the ledge extending out perpendicularly from the door near the top of the door with an optional pet cushion (shown dashed) resting on the ledge;

FIG. 2 is a side elevational view of the portable pet perching ledge of FIG. 1 with the ledge extending perpendicularly from the bottoms of the hooks for use;

FIG. 3 is a side elevational view of the portable pet perching ledge of FIG. 1 with the ledge pivoted onto the adjacent legs of the hooks;

FIG. 4 is a front elevational view of the portable pet perching ledge of FIG. 1 showing the invention mounted with the pair of hooks over the top of a door and the ledge extending out perpendicularly from the door near the top of the door with an pet cushion resting on the ledge and a cat resting on the pet cushion.

### DETAILED DESCRIPTION OF THE INVENTION

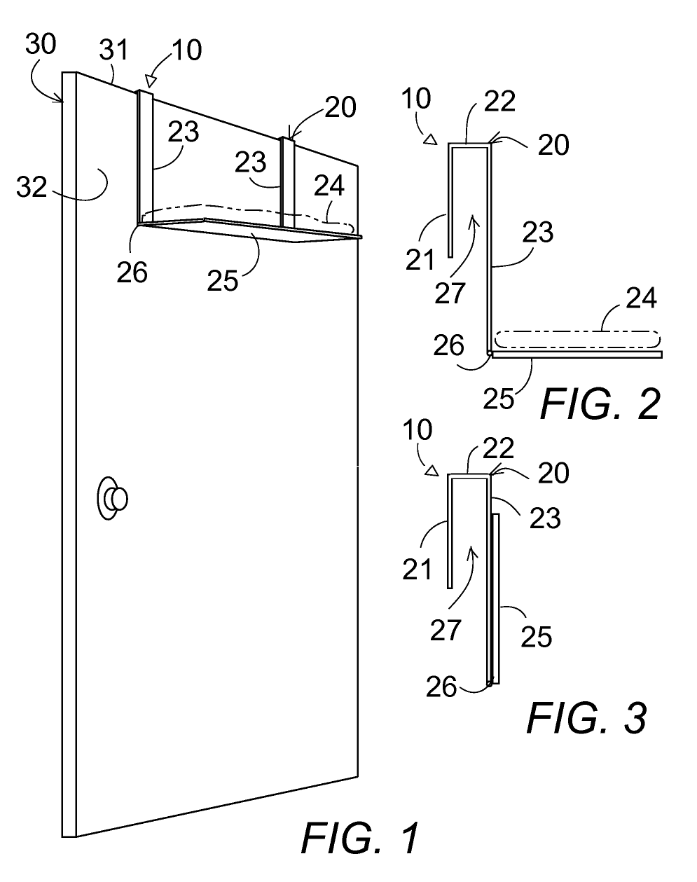

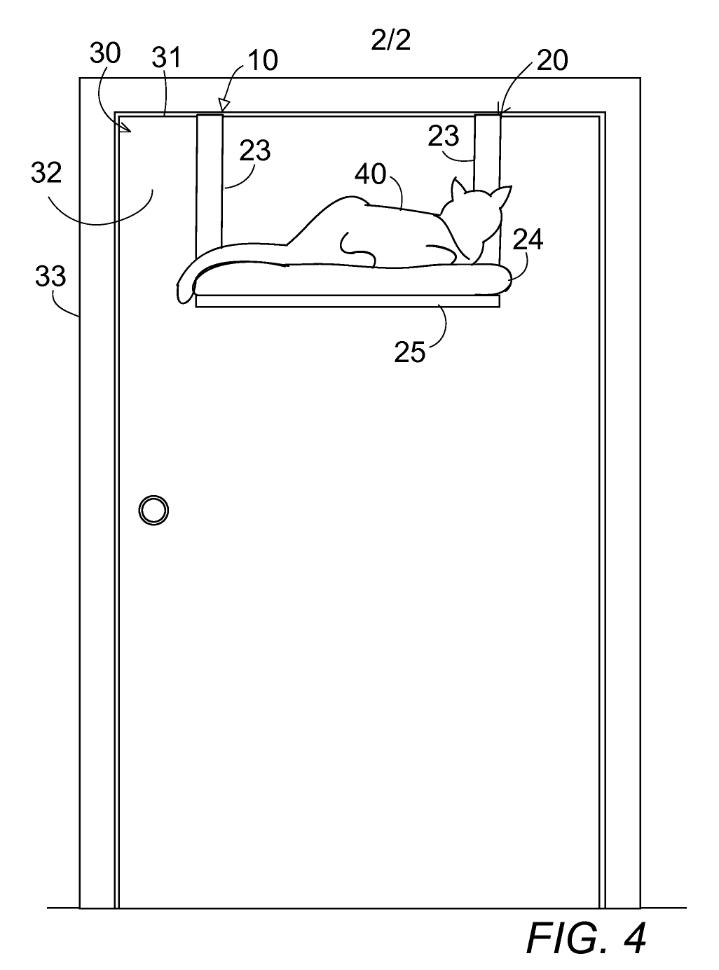

In FIGS. 1-2, a portable animal perching ledge device 10 comprises a hanger 20 formed of a pair of aligned inverted square U-shaped hooks 20 and a perpendicularly extending perching ledge 25 attached by a pivot device 26, such as a hinge or living hinge to the bottoms of the adjacent vertical legs 23 of the hooks with the device hooked over the top 31 of a door 30.

The hanger 20 comprises a pair of inverted square U-shaped hooks hung over a top 31 of a door 30 within a building, the hooks being fabricated of material sufficiently thin so that the hanger 20 does not interfere with opening and closing the door 30, the hooks fitting within the space between the frame 33 and the door 30. The hanger 20 comprises a front pair of vertical legs 23 aligned to fit against a face 32 of a door 30 and two horizontal top connecting plates 22 extending perpendicularly from the tops of the front pair of vertical legs 23 to rest on the top 31 of the door, and two back vertical legs 21 extending downwardly from the back edges of the two connecting plates 22 to rest against a back surface of the door 30 with a space 27 between the front legs 23 and the back legs 21 equal to the thickness of the door 30 to accommodate the door therein.

The horizontal perching ledge 25 is attached orthogonally to a bottom of a leg of each of the adjacent legs 23 of the hooks 20 on one face 32 of the door 30 and supported by the hanger 20 to accommodate a pet, such as a cat 40, lying on the perching ledge 25, as seen in FIG. 2. A pet cushion 24 is preferably provided for a pet positioned on the horizontal perching ledge 25 to rest on.

The horizontal perching ledge 25 is preferably attached to each of the adjacent legs 23 of the hanger 20 by a pivot means 26 for pivoting the perching ledge 25 up into contact with the pair of adjacent front legs 23 to which it is attached for storage.

The hanger 20 and the perching platform 25 are preferably fabricated of a molded material, such as plastic or fiberglass and the pivot means 26 for pivoting the perching ledge preferably comprises a living hinge. Alternately the hanger 20 and perching platform 25 may be fabricated of a metal sheet material and the pivot means 26 for pivoting the perching ledge may comprise a hinge. Any thin strong materials may be used.

In use, the hanger 20 device 10 is hooked over the top 31 of a door 30 and the perching ledge 25 pivoted out horizontally for use by a pet. A pet cushion 24 may be installed on the ledge 25.

A cat 40 using the present invention can leap from the floor or an adjacent piece of furniture up onto the perching ledge 25 and easily jump down. A cat or other pet enjoying high perches may also be placed up on the perching ledge. The ledge 25 is about 1.5 feet from top of door, so about 5 feet up from the floor.

It is understood that the preceding description is given merely by way of illustration and not in limitation of the invention and that various modifications may be made thereto without departing from the spirit of the invention as claimed.

What is claimed is:

1. A portable animal perching ledge device comprising:
a hanger comprising a pair of inverted square U-shaped hooks hung over a top of a door within a building, the hooks fabricated of material sufficiently thin so that the hanger does not interfere with opening and closing the door;
a horizontal perching ledge attached orthogonally to a bottom of a leg of each of the hooks on one side of the door and supported by the hooks to accommodate a pet lying on the perching ledge.

2. The device of claim 1 wherein the horizontal perching ledge is attached to each of the hooks by a means for pivoting the perching ledge up into alignment of the pair of legs to which it is attached for storage.

3. The device of claim 2 wherein the hanger and perching ledge are fabricated of a molded material and the means for pivoting the perching ledge comprises a living hinge.

4. The device of claim 2 wherein the hanger and perching ledge are fabricated of a metal sheet material and the means for pivoting the perching ledge comprises a hinge.

5. The device of claim 1 further comprising a cushion for a pet positioned on the horizontal perching ledge.
